(19) United States
(12) Patent Application Publication
(10) Pub. No.: US 2008/0141494 A1
(43) Pub. Date: Jun. 19, 2008

(54) HINGE ASSEMBLY FOR FOLDABLE ELECTRONIC DEVICE

(75) Inventors: SHENG-CHENG HSU, Tu-Cheng (TW); PU LUO, Shenzhen (CN); FAN-MING MENG, Shenzhen (CN); JIN-BU CAI, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/697,308

(22) Filed: Apr. 6, 2007

(30) Foreign Application Priority Data
Dec. 15, 2006 (CN) 200610201310.5

(51) Int. Cl. E05D 11/08

(52) U.S. Cl. 16/342

(57) ABSTRACT

An exemplary hinge assembly (30) includes a main mount (302), a pivot shaft (304), two active friction pieces (308, 309), two fixed friction pieces (306, 307), an elastic assembly (310, 311), and a fixing member (314). The active friction pieces are non-rotatably surrounded on the pivot shaft. The fixed friction pieces are rotatably surrounded on the pivot shaft. One fixed friction piece and one active friction piece are disposed at one side of the main mount and abutting each other. The other fixed friction piece and the other active friction piece are disposed at an opposite side of the main mount and abutting each other. The elastic assembly is surrounded on the pivot shaft and is configured to provide axial force. The fixing member is mounted at one end of the pivot shaft.

### BACKGROUND OF THE INVENTION

1. Field of the Invention

The present invention relates generally to hinge assemblies, and more particularly to a hinge assembly used in foldable electronic devices such as notebook computers.

2. Discussion of the Related Art

Nowadays, notebook computers are very popular due to its small-size and light weight. A notebook computer generally includes a main body and a liquid crystal display (LCD) body mounted on a main body. A hinge connects the LCD body and the main body, so that the LCD body can fold over the main body. The LCD body is rotatable by means of the hinge when users want to use the notebook computer. When the LCD body is flipped up to an appropriate position and angle, users may input information into the notebook computer via a keyboard on the main body, and text or graphical data can be displayed on a screen of the LCD body.

A typical hinge for connecting the LCD body to the main body of a notebook computer includes an L-shaped fixed seat, a pivotal axle, a flat washer, and an elastic washer. The fixed seat has a retaining hole defined therein. The pivotal axle is pivotally connected with the fixed seat. The pivotal axle has a retaining shoulder formed at a middle portion thereof, a connecting end portion integrally formed at a first end of the retaining shoulder, and a fixing end portion integrally formed at a second end of the retaining shoulder. The connecting end portion of the pivotal axle extends through a retaining hole of the fixed seat, the flat washer, the elastic washer, and then is fastened by a fastening piece. The flat washer and the elastic washer are disposed at one side of the fixed seat to provide friction force. However, the elements of the hinge, i.e., the fixed seat, the flat washer, the elastic washer and the fastening piece, are prone to become loosened from each. When this happens, the friction force is reduced. When the friction force is less than a gravity of the LCD body, the LCD body cannot retain at the desired position. That is, the LCD body is likely to rotate freely. As a result, the notebook computer is convenient to use.

Therefore, a new hinge assembly is desired in order to overcome the above-described shortcomings.

### SUMMARY

An exemplary hinge assembly includes a main body, a pivot shaft, two active friction pieces, two fixed friction pieces, an elastic assembly, and a fixing member. The active friction pieces are non-rotatably surrounded on the pivot shaft. The fixed friction pieces are rotatably surrounded on the pivot shaft. One of the fixed friction pieces and one of the active friction pieces are disposed on one side of the main body and abutting each other. The other fixed friction piece and the other active friction piece are disposed at an opposite side of the main body and abutting each other. The elastic assembly is surrounded on the pivot shaft and is configured to provide axial force. The fixing member is mounted at one end of the pivot shaft to prevent the main body, the fixed friction pieces, the active friction pieces and the elastic assembly from falling off from the pivot shaft.

An exemplary electronic device includes a first body, a second body, and a hinge assembly for rotatably connecting the first body and the second body. The hinge assembly includes a main body, a pivot shaft, two active friction pieces, two fixed friction pieces, an elastic assembly, and a fixing member. The active friction pieces are non-rotatably surrounded on the pivot shaft. The fixed friction pieces are rotatably surrounded on the pivot shaft. One of the fixed friction pieces and one of the active friction pieces are disposed on one side of the main body and abutting each other. The other fixed friction piece and the other active friction piece are disposed at an opposite side of the main body and abutting each other. The elastic assembly is surrounded on the pivot shaft and configured to provide axial force. The fixing member is mounted at one end of the pivot shaft to prevent the main body, the fixed friction pieces, the active friction pieces and the elastic assembly from falling off from the pivot shaft.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the hinge assembly and an associated electronic device. Moreover, in the drawings, like reference numerals designate corresponding parts throughout the several views.

FIG. 1 is an isometric view of a notebook computer with hinge assemblies in accordance with a preferred embodiment of the present invention, showing a display body, of the notebook computer, rotatable about an axis relative to the main body.

FIG. 2 is an exploded, isometric view of the hinge assembly employed in the notebook computer of FIG. 1.

FIG. 3 is an assembled view of the hinge assembly shown in FIG. 2.

FIG. 4 is a cross-sectional view of the hinge assembly shown in FIG. 3, taken along line IV-IV thereof.

### DETAILED DESCRIPTION OF THE EMBODIMENTS

The present application provides a hinge assembly used in foldable electronic devices that include two components rotatably attached to each other such as notebook computers and digital cameras (DCs). Hereinafter, for convenience and brevity, the hinge assembly as used in a notebook computer is described and illustrated.

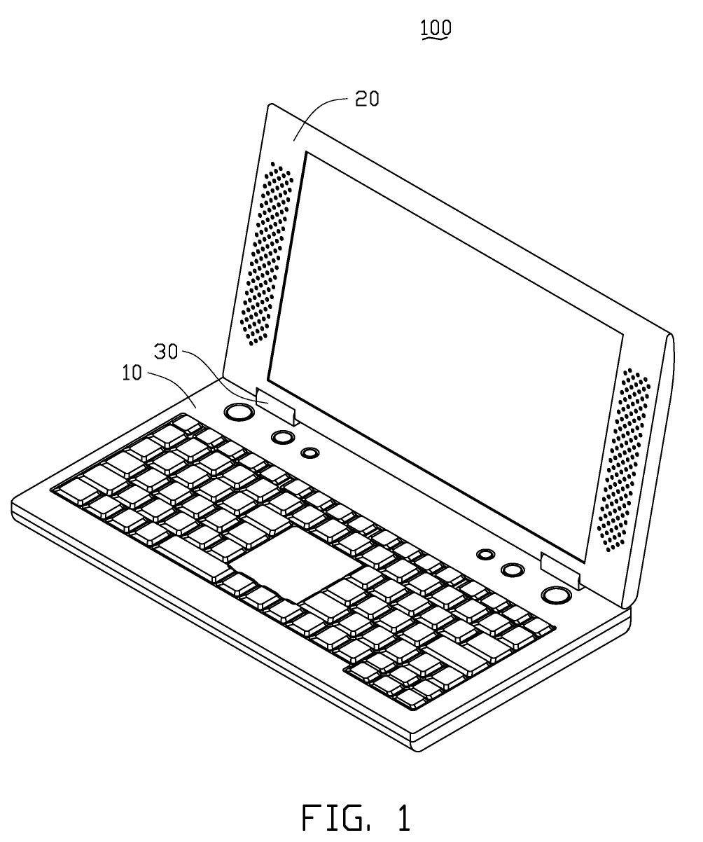

Referring to FIG. 1, a notebook computer 100 includes a main body 10, a display body 20, and a hinge assembly 30 rotatably connecting the main body 10 and the display body 20. As shown in FIG. 1, the display body 20 is flipped opened relative to the main body 10 at an angle.

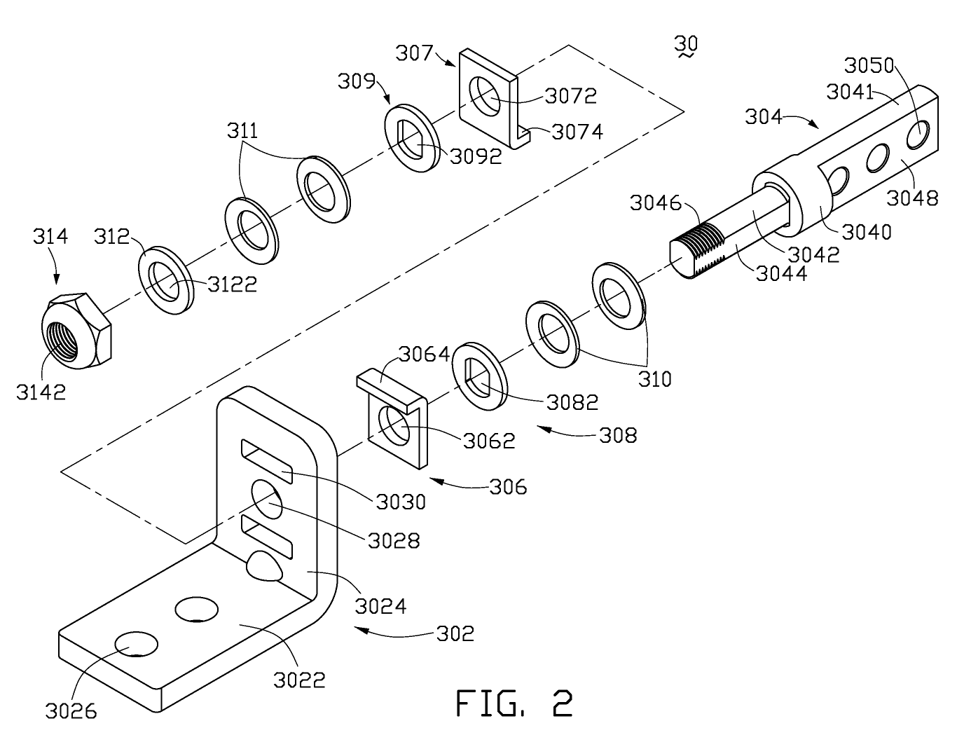

FIG. 2 shows the hinge assembly 30 of a preferred embodiment of the present invention. The hinge assembly 30 includes a main mount 302, a pivot shaft 304, two fixed friction pieces 306, 307, two active friction pieces 308, 309, two pairs of conical washers 310, 311, a washer 312, and a fixing member 314.

The main mount 302 includes a mounting portion 3022 and a pivoting portion 3024 perpendicular to the mounting portion 3022. The mounting portion 3022 and the pivoting portion 3024 are rectangular sheets. The mounting portion 3022 defines at least one mounting hole 3026. The main mount 302 is mounted to the main body 10 of the notebook computer 100 via the at least one mounting hole 3026. In this embodiment, there are two mounting holes 3026. The pivoting portion 3024 defines a circular pivoting hole 3028 with an axis aligned with a rotational axis of the hinge assembly 30 and two rectangular latching slots 3030. The latching slots 3030 are symmetrical defined at opposite sides of the pivoting hole 3028.

The pivot shaft 304 includes a base portion 3040, an assembling portion 3041 extending from one end of the base portion 3040, and a shaft portion 3042 extending from the other end of the base portion 3040 opposite to the assembly portion 3041. The base portion 3040 is cylindrical. The assembling portion 3041 is flattened at opposite sides forming two first flat surfaces 3048 parallel to an axis of the pivot shaft 304, thus having an approximate rectangular cross-section taken perpendicular to the axis. The assembling portion 3041 defines at least one assembling hole 3050. The pivot shaft 304 is mounted to the display body 20 of the notebook computer via the at least one assembling hole 3050. In the preferred embodiment, the assembling portion 3041 defines three assembling holes 3050. The shaft portion 3042 is flattened on opposite sides forming two opposite second flat surfaces 3044, thus defining a cross-section taken perpendicular the axis having a shape of a circle with two flattened sides. Alternatively, the cross-section of the shaft portion 3042 of the pivot shaft 304 may be any other non-circular shapes. For example, the cross-section can be triangular, pentagonal, or hexagonal. An end of the shaft portion 3042 defines a screw thread 3046.

The fixed friction pieces 306, 307 are rectangular sheets. The fixed friction piece 306 defines a circular center hole 3062 at a center and forms a bent tab 3064 bending 90 degrees. Similarly, the fixed friction piece 307 defines a circular center hole 3072 at a center and forms a bent tab 3074 bending 90 degrees. The bent tabs 3064, 3074 of the fixed friction pieces 306, 307 are respectively inserted into the latching slots 3030 of the main mount 302 so that the fixed friction pieces 306, 307 are fixed relative to the main mount 302.

The active friction pieces 308, 309 are circular sheets. The active friction piece 308 defines a keyed hole 3082 having a shape and a size the same as the cross-section of the shaft portion 3042 of the pivot shaft 304. Similarly, the active friction piece 309 defines a keyed hole 3092 having a shape and a size the same as the cross-section of the shaft portion 3042 of the pivot shaft 304. The active friction pieces 308, 309 are non-rotatably surrounded on the shaft portion 3042 of the pivot shaft 304.

The conical washers 310, 311 are dish-shaped. A pair of conical washers 310 are disposed opposite to each other. Another pair of conical washers 311 are also disposed opposite to each other. Each pair of conical washers 310, 311 are configured to provide an axial force. In other embodiments, a rubber bar, a helical spring, or other kind of elastic member may also be adopted to instead the conical washers 310, 311.

The washer 312 is a circular sheet having a circular through hole 3122 defined in a center of the washer 312.

The fixing member 314 is a nut defining a threaded hole 3142. The threaded hole 3142 of the fixing member 314 is configured to engaged with the screw thread 3046 of the pivot shaft 304 so that the fixing member 314 is detachably fixed to the pivot shaft 304. Therefore, the main mount 302, the fixed friction pieces 306, 307, the active friction pieces 308, 309, the conical washers 310, 311, and the washer 312 are prevented from detaching off the pivot shaft 304.

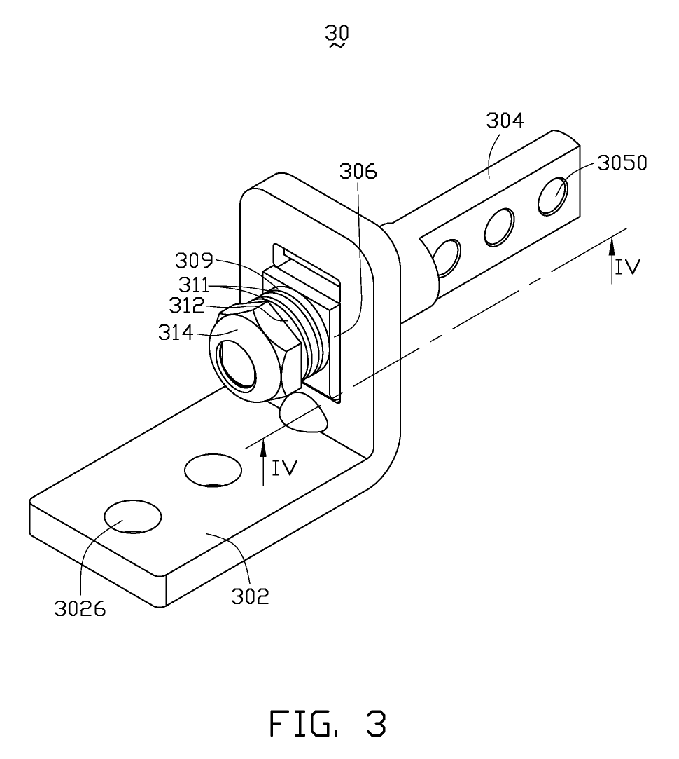

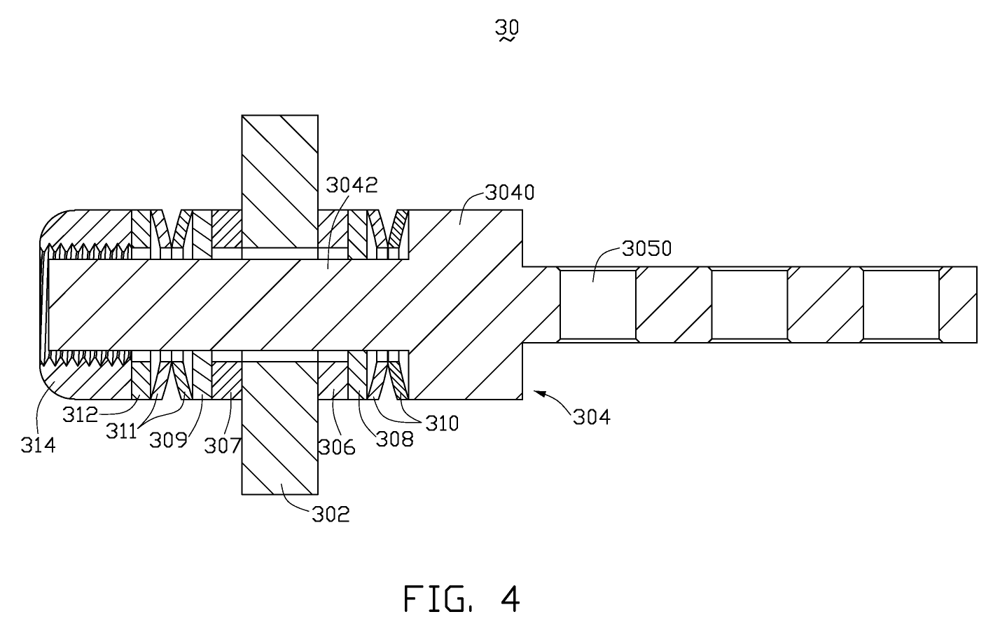

Referring to FIG. 3 and FIG. 4, in order to assemble the hinge, the bent tabs 3064, 3074 respectively of the fixed friction piece 306, 307 are inserted into the latching holes 3030 of the main mount 302 correspondingly. The shaft portion 3042 of the pivot shaft 304 is inserted through the pair of conical washers 310, the active friction piece 308, the fixed friction piece 306, the main mount 302, the fixed friction piece 307, the active friction piece 309, the pair of conical washers 311, and the washer 312, in that order. The fixing member 314 is screwed into the pivot shaft 304 by engaging with the screw thread 3046. In the assembling of the hinge assembly 30, shown in FIG. 3 and FIG. 4, the fixed friction pieces 306, 307 are fixed relative to the main mount 302, the active friction pieces 308, 309 are non-rotatable relative to the pivot shaft 304, and the pivot shaft 304 is rotatable relative to the main mount 302. The main body 10 and the display body 20 of the notebook computer are connected together by mounting the main mount 302 to the main body 10 and mounting the pivot shaft 304 to the display body 20.

In use, when the display body 20 is manually rotated relative to the main body 10 about the rotational axis, the pivot shaft 304 and the active friction pieces 308, 309 rotate together with the display body 20 relative to the main mount 302 and the fixed friction pieces 306, 307 being fixed relative to the main body 10. The axial force provided by the conical washers 310, 311 pushes the active friction pieces 308, 309 to abut the fixed friction pieces 306, 307 respectively. Thus an axial force exists between the active friction piece 308 and the fixed friction piece 306, and an axial force exists between the active friction piece 309 and the fixed friction piece 307. When the active friction pieces 308, 309 rotate relative to the fixed friction pieces 306, 307, friction forces are generated between the active friction piece 308 and the fixed friction piece 306, and also between the active friction piece 309 and the fixed friction piece 307. Thus, a friction moment is generated in the hinge assembly 30. In this manner, the fixed friction piece 306 and the active friction piece 308 are disposed on a side of the main mount 302, and the fixed friction piece 307 and the active friction piece 309 are disposed at another side of the main mount 302, thus forming a dual-side friction configuration. This dual-side friction configuration can increase the friction moment in the hinge assembly 30 allowing the pivot shaft 304 to maintain position relative to the main mount 302. Accordingly, the display body 20 would also maintain position relative to the main body 10.

In alternative embodiments, the screw thread 3046 of the pivot shaft 304 and the fixing member 314 may be omitted. Instead, for example, the pivot shaft 304 defines an annular slot and a ring is provided to engage in the annular slot. In another example, one end of the pivot shaft 304 is riveted by a riveting machine after the hinge assembly 30 is assembled. The main mount 302 can be fixedly connected to the display body 20 and the pivot shaft 304 can be fixedly connected to the main body 10 correspondingly.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A hinge assembly, comprising:
a main mount;
a pivot shaft;
two active friction pieces non-rotatably surrounded on the pivot shaft;
two fixed friction pieces rotatably surrounded on the pivot shaft, one of the fixed friction pieces and one of the active friction pieces abuts each other and disposed at a side of the main mount, and another one of the fixed friction pieces and another one of the active friction pieces abuts each other and disposed at another side of the main mount;
an elastic assembly surrounded on the pivot shaft and configured to provide axial force; and
a fixing member mounted at an end of the pivot shaft to prevent the main mount, the fixed friction pieces, the active friction pieces and the elastic assembly from detaching from the pivot shaft.

2. The hinge assembly as claimed in claim 1, wherein the elastic assembly comprises two pairs of conical washers, a pair of the conical washers are disposed at a side of the main mount and another pair of conical washers are disposed at another side of the main mount.

3. The hinge assembly as claimed in claim 2, wherein the pair of the conical washers are disposed opposite to each other.

4. The hinge assembly as claimed in claim 1, wherein the main mount comprises a pivoting portion, the pivoting portion defines a circular pivoting hole with an axis aligned with a rotational axis of the hinge assembly and further defines two latching slots, the pivot shaft comprises a shaft portion to rotatably insert through the pivoting hole of the main mount, each of the fixed friction pieces defines a circular center hole in a center thereof to allow the shaft portion of the pivot shaft to be inserted through.

5. The hinge assembly as claimed in claim 4, wherein the latching slots are rectangular and symmetrical at opposite sides of the pivoting hole, each of the fixed friction pieces forms a bent tab for being inserted into the latching slots of the main mount so that the fixed friction pieces are fixed relative to the main mount.

6. The hinge assembly as claimed in claim 5, wherein the fixed friction pieces are rectangular sheets, the bent tabs are formed by bending an end of the fixed friction pieces 90 degrees.

7. The hinge assembly as claimed in claim 4, wherein the main mount further comprises a mounting portion perpendicular to the pivoting portion, the mounting portion and the pivoting portion are rectangular sheets, the mounting portion defines at least one mounting hole.

8. The hinge assembly as claimed in claim 4, wherein the shaft portion of the pivot shaft is key-shaped, each of the active friction piece defines a keyed hole having a shape and a size the same as the cross-section of the shaft portion of the pivot shaft so that the active friction pieces are non-rotatably surrounded on the shaft portion of the pivot shaft.

9. The hinge assembly as claimed in claim 8, wherein the active friction pieces are circular sheets, the shaft portion of the pivot shaft is flattened to form two flat surfaces at opposite sides of the shaft portion, thus defining a cross-section taken perpendicular an axis of the pivot shaft having a shape of a circle with two flattened sides.

10. The hinge assembly as claimed in claim 8, wherein the pivot shaft further comprises a base portion and an assembling portion extending from one end of the base portion, the shaft portion extends from an opposite end of the base portion, the base portion is cylindrical, an end of the shaft portion defines a screw thread, and the fixing member is a nut engaging with the screw thread of the pivot shaft.

11. The hinge assembly as claimed in claim 8, wherein the assembling portion of the pivot shaft is flattened to form two opposite first flat surfaces extending parallel to an axis of the pivot shaft, thus defining a cross-section taken perpendicular an axis of the pivot shaft having an approximate rectangular cross-section.

12. The hinge assembly as claimed in claim 1, wherein further comprising a washer disposed adjoining to the fixing member.

13. An electronic device comprising:
a first body;
a second body; and
a hinge assembly rotatably connecting the first body and the second body, the hinge assembly comprising:
a main mount non-rotatably connected to one of the first and second bodies;
a pivot shaft non-rotatably connected to the other one of the first and second bodies;
two active friction pieces non-rotatably surrounded on the pivot shaft;
two fixed friction pieces rotatably surrounded on the pivot shaft, one of the fixed friction pieces and one of the active friction pieces being disposed at one side of the main mount and abutting each other, and the other one of the fixed friction pieces and the other one of the active friction pieces disposed at an opposite side of the main mount and abutting each other;
an elastic assembly surrounded on the pivot shaft and configured to provide axial force; and
a fixing member mounted at one end of the pivot shaft to prevent the main mount, the fixed friction pieces, the active friction pieces and the elastic assembly from falling off from the pivot shaft.

14. The electronic device as claimed in claim 13, wherein the elastic assembly comprises two pairs of conical washers, one pair of conical washers are disposed at the one side of the main mount and the other pair of conical washers are disposed at the opposite side of the main mount, the conical washers are dish-shaped, and each pair of conical washers are disposed opposite to each other.

15. The electronic device as claimed in claim 13, wherein the main mount comprises a pivoting portion, the pivoting portion defines a circular pivoting hole with an axis aligned with a rotational axis of the hinge assembly and two latching slots, the pivot shaft comprises a shaft portion for rotatably inserted into the pivoting hole of the main mount, each of the fixed friction pieces defines a circular center hole in a center thereof for allowing the shaft portion of the pivot shaft to run through.

16. The hinge assembly as claimed in claim 15, wherein the main mount further comprises a mounting portion perpendicular to the pivoting portion, the mounting portion and the pivoting portion are rectangular sheets, the mounting portion defines at least one mounting hole, the main mount is mounted to one of the first and second bodies of the electronic device via the at least one mounting hole.

17. The hinge assembly as claimed in claim 16, wherein the pivot shaft further comprises a base portion and an assembling portion extending from one end of the base portion, the shaft portion extends from an opposite end of the base portion, the base portion is cylindrical, the assembling portion defines at least one assembling hole, the pivot shaft is mounted to the display body of the notebook computer via the at least one assembling hole.

18. A hinge assembly, comprising:
a main mount defining a pivoting hole;
a pivot shaft rotatably running through the pivoting hole of the main mount;
a pair of first friction pieces disposed at one side of the main mount and abutting each other, one of the first friction pieces non-rotatably surrounded on the pivot shaft and the other one of the first friction pieces non-rotatably mounted to the main mount;
a pair of second friction pieces disposed at an opposite side of the main mount and abutting each other, one of the second friction pieces non-rotatably surrounded on the pivot shaft and the other one of the second friction pieces non-rotatably mounted to the main mount; and
an elastic assembly surrounded on the pivot shaft and configured to provide axial force.
